(19) United States
(12) Patent Application Publication
(10) Pub. No.: US 2019/0305692 A1
(43) Pub. Date: Oct. 3, 2019

(54) Transformer-less Tapped Point AC Voltage Splitter for Full Bridge DC AC Inverters

(71) Applicants: James Augustus Allen, JR., Gilroy, CA (US); William Benjamin Reed, San Jose, CA (US); Eugene Francis Krzywinski, San Jose, CA (US)

(72) Inventors: James Augustus Allen, JR., Gilroy, CA (US); William Benjamin Reed, San Jose, CA (US); Eugene Francis Krzywinski, San Jose, CA (US)

(21) Appl. No.: 16/367,247

(22) Filed: Mar. 28, 2019

Related U.S. Application Data
(60) Provisional application No. 62/649,198, filed on Mar. 28, 2018.

(51) Int. Cl. H02M 7/537; H02M 1/00

(52) U.S. Cl. CPC H02M 7/537; H02M 2001/0048; H02M 1/00

(57) ABSTRACT

This disclosure describes an innovative circuit that is an alternative to large, costly transformers used for the purpose of splitting an AC voltage into two equal, half amplitude waveforms. Typical utility serviced entities have a single phase that is split into two thus providing 240Vac and two branches of 120Vac that are out of phase relative to each other. DC to AC inverters that are required to provide the same type of service, use transformers at their output to split that output into the same levels. These transformers, in addition to cost and size, adversely affect the efficiency of the system. This invention replaces the transformer with a capacitor based solution that is less costly, very much smaller and has virtually no impact on system efficiency. In addition, this invention can tolerate 100% load imbalance between the split voltages, reducing the need for precise balancing of the loads at the electrical distribution panel. The invention is applicable to multiple level DC AC inverters, as well as paralleled DC AC inverters.

### CROSS REFERENCE TO RELATED APPLICATIONS

This application claims the benefit of U.S. Provisional Application No. 62/649,198 “Transformer-less, capacitor based neutral point reference for splitting AC output from DC AC Inverters” filed on Mar. 28, 2018, the entirety of which is incorporated herein by this reference thereto.

### TECHNICAL FIELD OF THE INVENTION

The invention relates to splitting the AC output voltage of DC to AC inverters into two equal amplitude voltages.

### BACKGROUND

Conversion from DC to AC is a critical part of utilizing renewable energy for consumption in virtually all industrialized countries, as well as many of the emerging countries and societies. In the US, the national grid provides a network of power, capable of multiple voltages and phases. In this regard, the national grid can be considered both an infinite source and infinite sink and is therefore a reliable reference point for all things electrical. For solar installations, the energy is harvested in DC and converted to AC that is sync'd to the grid for grid tied applications. Off-grid applications though, have no grid to which it can be sync'd and therefore reference is usually to earth.

In the US, the grid supply to residences and small business is typically a single phase, in order to keep transmission and distribution costs low. However, many appliances, such as ovens, air conditioners, electric dryers and emerging charging stations for EVs benefit from a voltage that is much higher than standard household appliances and so the electrical distribution panel typically supplies both 240Vac and 120Vac. In order to keep distribution infrastructure costs low and supplying these two voltages, the utility supplies the 240Vac. This 240Vac is composed of three wires from one of the phases of a three phase network, where the three wires are designated as L1 and L2 and N. This configuration provides 240Vac when the wires are referenced to each other and 120Vac when one of the wires is referenced to a neutral point, or earth in this case. The two 120Vac supplies are 180° out of phase with each other because of the transformer winding polarity used by the utility.

### CURRENT STATE OF THE ART

Grid-tied inverters, especially over 1 kW in power rating, transfer their power at 240Vac (or local utility voltage) and do not need to split that output into two 120V lines. Off-grid inverters, however, must supply both the 240Vac and 120Vac voltages and do so using a scaled down version of the utility transformer which splits the voltage into two out of phase AC voltages. These transformers are costly and heavy, increasing with power rating. As more renewable energy sources, which are predominantly DC, are installed, the dependence on the utility grid decreases. In some cases, it may not be present at all. The power requirement for an off-grid inverter may be several times that needed for a grid-tied inverter for the same dwelling size, and the transformer required to provide single and split phase output may be on the order of several hundred pounds weight. Such a transformer is bulky, taking up considerable space for itself and the necessary area clearance for thermal dissipation. They are typically comprised of heavy iron cores, and large gauge copper windings and also consume power even at no-load conditions. The split phase transformer will also have continuous power loss at both of the AC output voltage levels, whereas the invention only has a fraction of a loss during a severe unbalanced condition.

Several approaches have been tried with solid state implementations, however, those are complex and costly and still require a phase splitting transformer, although of a smaller size.

### SUMMARY OF THE INVENTION

The invention provides an innovative, small form factor, lower cost, capacitor based alternative to the bulky iron core transformers (inductive based transformations).

### BRIEF DESCRIPTION OF THE DRAWINGS

FIG. 1 is a schematic diagram of the current state of the art for transformer based output voltage splitting from a DC AC inverter

FIG. 2 is an embodiment of the invention illustrating the replacement of the transformer based voltage splitting function with a capacitor based function.

FIG. 3 is a schematic diagram of an embodiment of the invention.

FIG. 4 is an illustration of the output split voltage waveforms showing no-load and load conditions.

### DETAILED DESCRIPTION OF THE INVENTION

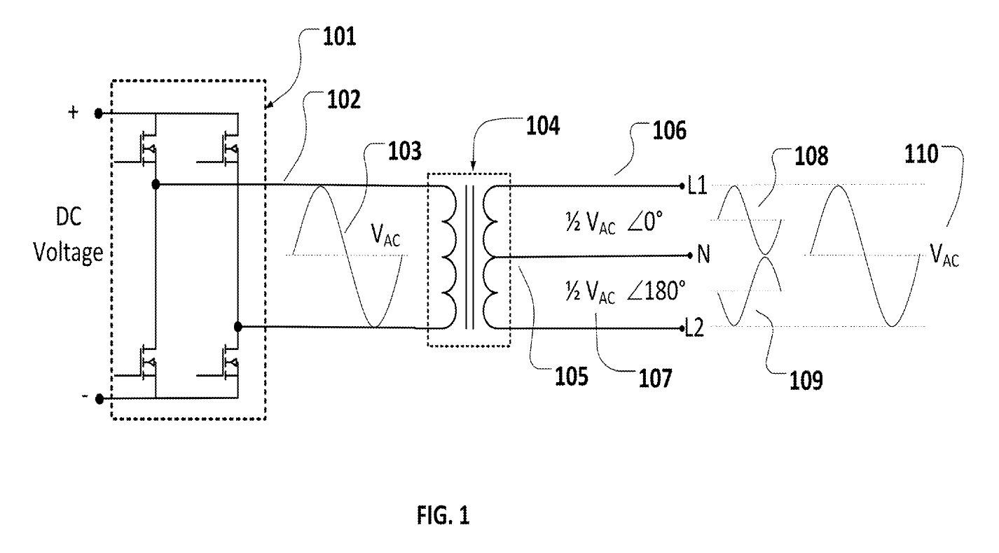

FIG. 1 illustrates the current implementation for splitting a single AC voltage into two voltages that are half the amplitude of the original voltage, while also maintaining an output which has the original amplitude. The inverter [101] has an output [103] of Vac at a given frequency. This output is received by the transformer [104] which has a primary winding on its input side, and the center tapped secondary winding produces two outputs, L1 [106] and L2[107] that are 180 degrees out of phase with respect to each other. These outputs share a common neutral point [105]. If a connection is made between one of these output lines, L1 or L2, and the neutral, N, the voltage will be one-half of the inverter's output AC voltage [103]. When the connection is made between the two output lines L1 and L2, then the AC voltage will be equal to the inverter's output AC voltage [103]. While this phase splitting is provided by the utility, when utility service is provided, achieving the same with an off-grid DC AC inverter necessitates that the voltage be split, although the voltage phases, relative to each other, is irrelevant and the 180 degree phase shift when a transformer is used is an artifact of keeping manufacturing costs down through using a winding center tap, rather then two separate output windings.

Higher power inverters require increasingly larger transformers, resulting in more costly, heavier and less efficient devices, because of their iron cores and large gauge copper windings. Additionally, transformer windings are specific to narrow ranges of frequencies so the transformers are application specific designs and are not interchangeable with those designed for a different frequency of operation.

In an embodiment of the invention, the transformer is replaced by a module [204] comprising a circuit [204] that effectively provides a center voltage neutral point [208] between the two terminals L1 [206] and L2 [207] thereby splitting the inverter's AC output voltage [205] into two, equal, half amplitude output voltages [209] and [210] while still maintaining an AC voltage output [210] equal to the inverter's output [205]. In this embodiment, the output voltages [209] and [210] are in-phase relative to each other and to the inverter's AC output [205]. The circuit

can be used with two or higher level inverter topologies. Unlike multi-level inverter topologies employing DC-link capacitor pairs for each level, and therefore connectivity complexity, the invention allows the use of just two banks of capacitors, regardless of the number of levels within the inverter.

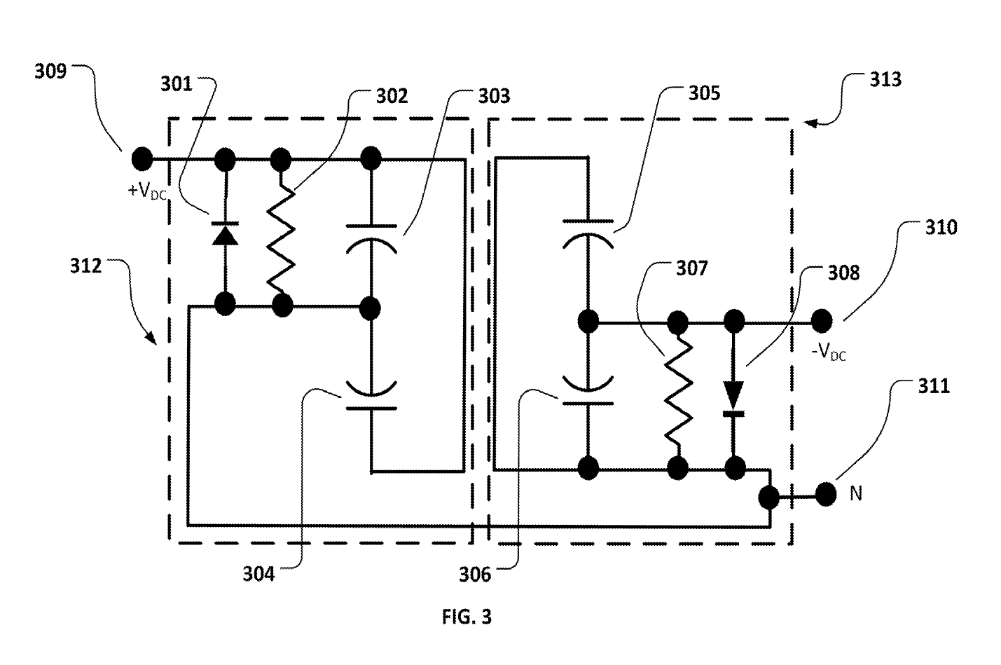

FIG. 3 illustrates detail of an embodiment of the invention. Two banks of capacitors [303] [304] and [305][306] generate a neutral point [311] between the positive DC inverter input voltage [309] and negative DC inverter input voltage [310]. Resistors [302] and [307] and diodes [301] and [308] adjust any imbalance between the AC outputs L1 [209] and L2 [201]. Even though the module [204] is referenced to the DC Voltage, it does not affect the amplitude of the AC output voltage [205] generated by the inverter [203].

Selection of the capacitors [303][304][305] and [306] is determined by the system output voltage Vac [211] and power capacity of the inverter [203]. The capacitors must be properly specified for voltage limits and optimized for the desired ripple current reduction caused by incomplete AC waveform suppression within the inverter. Capacitance value is driven by the power capacity of the system, the desired level of imbalance tolerance between the split voltages and the desired impedance or reactance of the module [204].

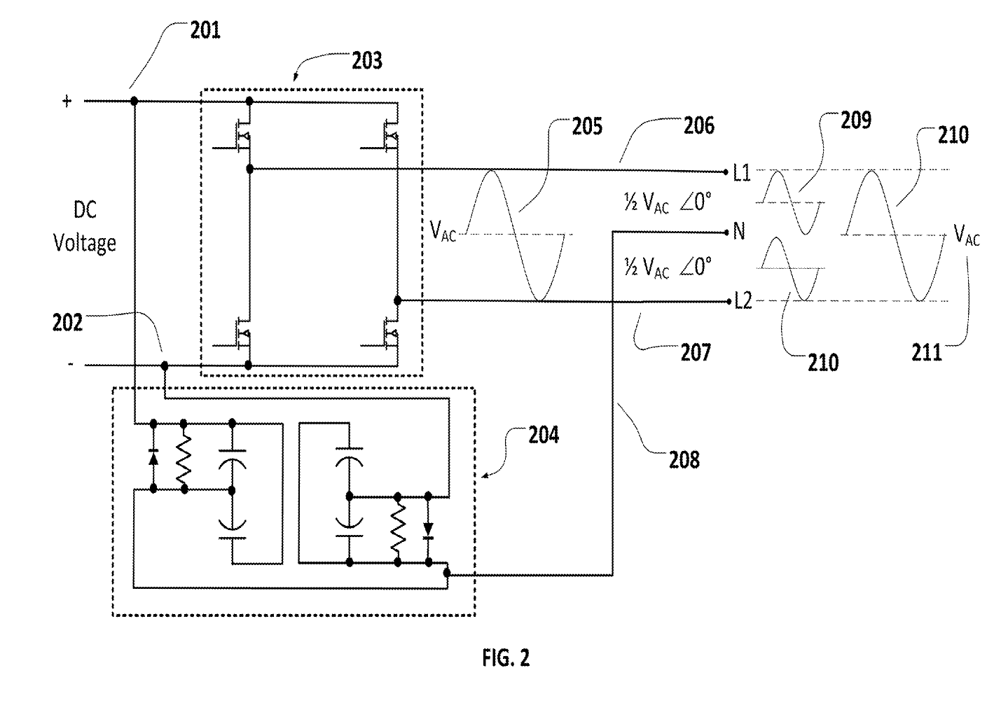

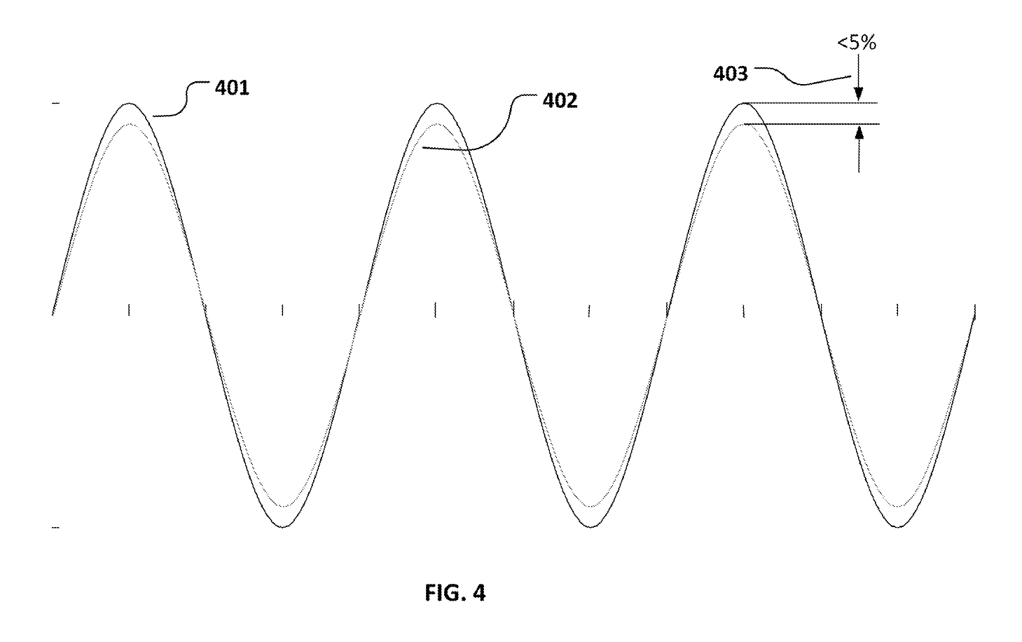

FIG. 4 illustrates the advantage of one embodiment of the invention. Unbalanced loads present a problem in multi-level inverter DC-link capacitors and significant analytic study is required to determine the proper capacitance. In the embodiment illustrated in FIG. 2, the output waveforms were measured with one output [401] at no-load and the other output [402] at full load. Superimposing both waveforms as in FIG. 4 shows a deviation of less than 5% [403]

Unlike transformer based solutions as illustrated in FIG. 1, whereby different line frequencies necessitate that each different transformer [104] has a unique wire winding tailored to the line frequency, the invention can be used across a wide range of common frequencies, in one embodiment between 50 Hz and 400 Hz, using the same component values. This provides flexibility, especially when the invention is retrofitted to an existing power system.

In another embodiment of the invention, an inductor can be inserted between the AC output L1 and the neutral output [208] and a second, identical inductor between AC output L2 [207] and the neutral output [208] to improve the voltage center point establishment, especially during start-up or rapidly changing load conditions. In this embodiment, the resistors [302] and [307] may or may not be present.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims:

What is claimed is:

1. A device operative to split an output electrical voltage from output terminals of a DC to AC inverter into two AC voltages, wherein the two AC voltages are of equal amplitude, and wherein an input electrical voltage to the DC to AC inverter provides a reference for a balanced midpoint, N, of said output electrical voltage, comprising:
at least one module comprising:
two identical circuits, comprising capacitors, resistors and diodes, configured to create the balanced midpoint N between terminals +Vdc and −Vdc;
wherein:
outputs formed between a first output from the DC to AC inverter and the balanced midpoint N, and between a second output from the DC to AC inverter and the balanced midpoint N operate at equal or unequal currents depending on their respective loads and independent of each other; and
an output formed between the first output from the DC to AC inverter and the second output from the DC to AC inverter operate at a current independent of the other outputs.

2. The device of claim 1 in which one inductor is connected between the first output from the DC to AC inverter and the balanced midpoint N and a second, equal value inductor is connected between the second output from the DC to AC inverter and the balanced midpoint N to improve the voltage center point establishment.

3. The device of claim 1 wherein a multiplicity of the at least one module are connected in parallel.

4. The device of claim 1 wherein the at least one module comprises capacitors, each of which is one or more capacitors.

5. A system comprised of a multiplicity of devices of claim 1 are connected in parallel.

6. The device of claim 1 wherein the at least one module is integrated into the DC AC inverter.

7. The device of claim 1 wherein the at least one module is not integrated into the DC AC inverter.
